(19) United States
(12) Patent Application Publication
(10) Pub. No.: US 2025/0050954 A1
(43) Pub. Date: Feb. 13, 2025

(54) BARRICADE FOR SUPPRESSING BEHAVIOR OF SPARE TIRE

(71) Applicants: Hyundai Motor Company, Seoul (KR); Kia Corporation, Seoul (KR)

(72) Inventors: Hyun-Bin Kim, Incheon (KR); Yong-Ho Jun, Seongnam-si (KR); Sung-Won Kim, Hwaseong-si (KR); Je-Won Kwon, Hwaseong-si (KR)

(21) Appl. No.: 18/511,307

(22) Filed: Nov. 16, 2023

(30) Foreign Application Priority Data
Aug. 11, 2023 (KR) 10-2023-0105590

(51) Int. Cl. B62D 43/10

(52) U.S. Cl. CPC B62D 43/10

(57) ABSTRACT

An embodiment barricade for suppressing a behavior of a spare tire includes a support portion configured to be mounted on a spare tire well panel and a protruding portion extending from the support portion and protruding to a spare tire side. In an embodiment, the protruding portion is spaced apart from the spare tire well panel.

### CROSS-REFERENCE TO RELATED APPLICATIONS

This application claims the benefit of Korean Patent Application No. 10-2023-0105590, filed on Aug. 11, 2023, which application is hereby incorporated herein by reference.

### TECHNICAL FIELD

The present disclosure relates to a barricade for suppressing a behavior of a spare tire.

### BACKGROUND

A spare tire is stored in a lower space of a trunk of a vehicle, and the spare tire is stored by being accommodated in a spare tire well panel for accommodating the spare tire.

However, in the event of a rear-end collision accident, in particular, a rear seat of the vehicle directly receives a lot of energy.

In particular, in the case of a family car, since children sit on a rear seat in many cases, it is more important to protect passengers at the rear seat.

In addition, in the case of a multi-link suspension having a smaller depth of the spare tire well panel, there is a risk that the spare tire is separated after a rear-end collision to hit a backrest of the rear seat from behind.

Therefore, there is a problem in that collision energy from a rear barrier and collision energy from a hit by the separated spare tire are added, thereby increasing injury to passengers at the rear seat.

Matters described above in the background are intended to help understanding of the background of embodiments of the disclosure and may include matters not related to the related art already known to those skilled in the art to which this technology pertains.

### SUMMARY

The present disclosure relates to a barricade for suppressing a behavior of a spare tire. Particular embodiments relate to a barricade for suppressing a behavior of a spare tire provided in a vehicle in the event of collision accidents of the vehicle.

Embodiments of the present disclosure can solve problems in the art and provide a barricade for suppressing a behavior of a spare tire, which may restrict the spare tire hitting a rear seat in the event of a rear-end collision of a vehicle.

A barricade for suppressing a behavior of a spare tire according to one embodiment of the present disclosure is a barricade mounted on a spare tire well panel in which a spare tire is accommodated and configured to suppress a behavior of a spare tire and includes a support portion mounted on the spare tire well panel and a protruding portion extending from the support portion and protruding to the spare tire side.

In addition, the protruding portion may be spaced apart from the spare tire well panel.

Specifically, the protruding portion may be spaced apart from an inclined portion formed to be inclined from a front upper end portion of the spare tire well panel to a recessed portion of the spare tire well panel in which the spare tire is accommodated.

Meanwhile, each of the support portions may be formed to extend from both end portions of the protruding portion in a width direction.

Here, the support portion may include an upper support portion coupled to a front upper end portion of the spare tire well panel and a lower support portion coupled to an inclined portion formed to be inclined from the front upper end portion to a recessed portion of the spare tire well panel in which the spare tire is accommodated.

In addition, a plurality of protruding portions may be formed to be spaced apart from each other, and a cutout portion may be formed between the plurality of protruding portions.

In addition, the protruding portion may have a shape rounded to be convex to the spare tire side.

Next, a barricade for suppressing a behavior of a spare tire according to another embodiment of the present disclosure is a barricade mounted on a spare tire well panel in which a spare tire is accommodated and configured to suppress a behavior of a spare tire and includes a support portion mounted on the spare tire well panel and a protruding portion extending from the support portion, protruding to the spare tire side, and spaced apart from the spare tire well panel, wherein the support portion is formed to extend from both end portions of the protruding portion in a width direction.

Here, the support portion may include an upper support portion coupled to a front upper end portion of the spare tire well panel and a lower support portion coupled to an inclined portion formed to be inclined from the front upper end portion to a recessed portion of the spare tire well panel in which the spare tire is accommodated.

In addition, a plurality of protruding portions may be formed to be spaced apart from each other, and a cutout portion may be formed between the plurality of protruding portions.

In addition, the protruding portion may have a shape rounded to be convex to the spare tire side.

When the barricade for suppressing the behavior of the spare tire according to embodiments of the present disclosure is applied, it is possible to protect passengers at the rear seat from the separated spare tire in the event of the rear-end collision of the vehicle.

Since the above-described structure of the barricade according to embodiments of the present disclosure does not affect the package layout of the spare tire well, it is advantageous to secure the loading space.

In addition, it is possible to not only minimize the increase in the weight of the vehicle, but also effectively suppress the behavior of the spare tire.

### BRIEF DESCRIPTION OF THE DRAWINGS

FIG. 1 is a view illustrating a state in which a barricade according to embodiments of the present disclosure is mounted on a spare tire well panel.

FIG. 2 is a view schematically illustrating a cross section of the barricade of FIG. 1.

FIG. 3 is a perspective view illustrating the barricade according to embodiments of the present disclosure.

FIG. 4 is a front view illustrating the barricade according to embodiments of the present disclosure.

FIG. 5 is a top view illustrating the barricade according to embodiments of the present disclosure.

FIG. 6 is a view illustrating the barricade based on the cross section of FIG. 4.

FIG. 7 is a comparison view with FIG. 6.

FIGS. 8 to 10 are views for describing applied shapes of the barricade according to embodiments of the present disclosure.

### DETAILED DESCRIPTION OF ILLUSTRATIVE EMBODIMENTS

For a full understanding of embodiments of the present disclosure, operational advantages of embodiments of the present disclosure, and objects to be achieved by practicing embodiments of the present disclosure, reference should be made to the accompanying drawings, which illustrate preferred embodiments of the present disclosure, and contents described in the accompanying drawings.

In describing the preferred embodiments of the present disclosure, a description of known techniques or repetitive descriptions that may unnecessarily obscure the gist of the embodiments of the present disclosure will be reduced or omitted.

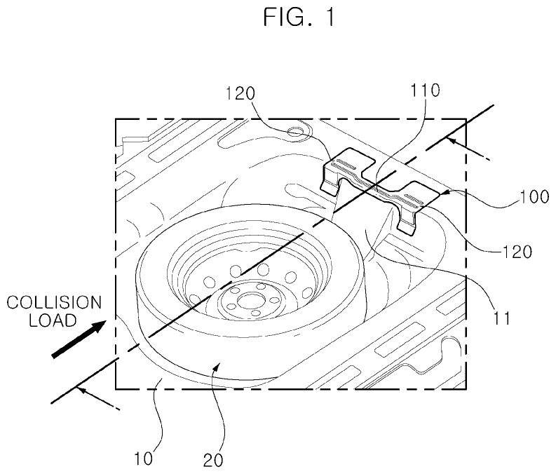

FIG. 1 is a view illustrating a state in which a barricade according to embodiments of the present disclosure is mounted on a spare tire well panel.

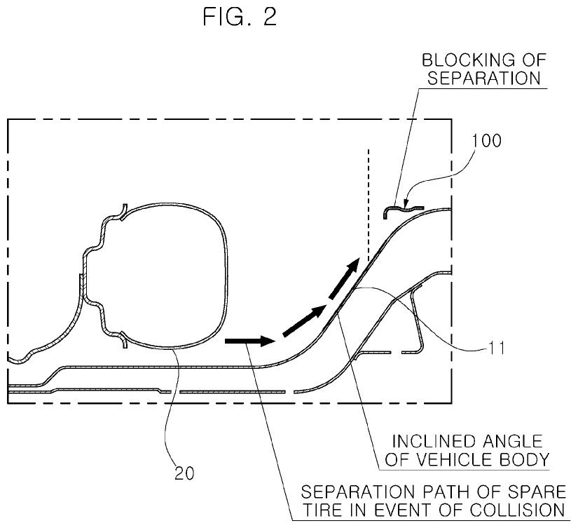

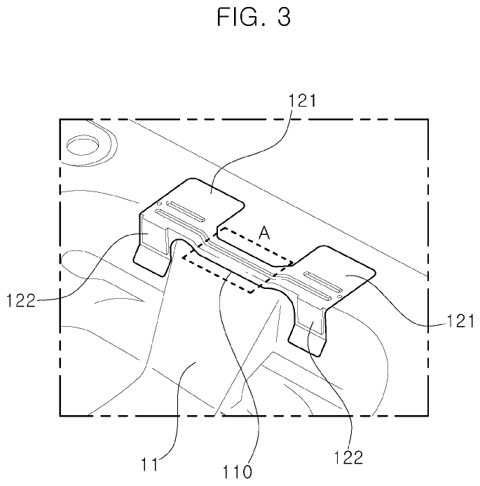

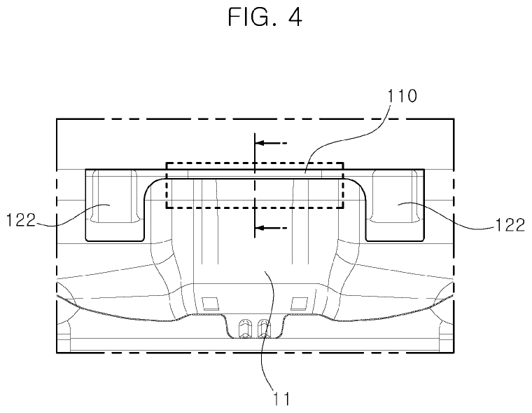

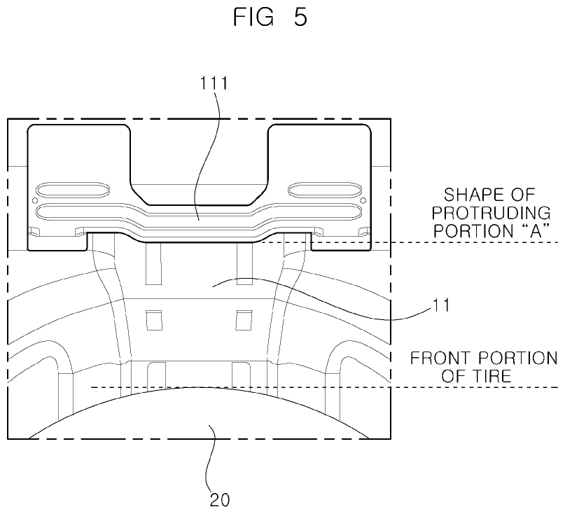

FIG. 2 is a view schematically illustrating a cross section of the barricade of FIG. 1, and FIG. 3 is a perspective view illustrating the barricade according to embodiments of the present disclosure. In addition, FIG. 4 is a front view illustrating the barricade according to embodiments of the present disclosure, and FIG. 5 is a top view illustrating the barricade according to embodiments of the present disclosure.

Hereinafter, a barricade for suppressing a behavior of a spare tire according to one embodiment of the present disclosure will be described with reference to FIGS. 2 to 5.

A spare tire well panel 10 for accommodating a spare tire includes a recessed accommodating portion for accommodating a spare tire 20 and an upper end portion coupled to a vehicle body by forming a step difference with the accommodating portion, and in particular, in order to secure moldability, an inclined portion 11 extending at a smooth inclination from the accommodating portion to the upper end portion is formed at a front portion side of the vehicle.

Therefore, as illustrated in FIG. 2, there occurs a phenomenon in which the spare tire receiving a strong collision load at the rear is pushed forward and hits a backrest of a rear seat while moving up along an inclination angle of the vehicle body.

In this case, the inclination angle is necessarily reflected to secure the moldability of a vehicle body panel.

The barricade according to embodiments of the present disclosure is a structure for blocking collision energy transmitted to the rear seat by suppressing the behavior of the spare tire moving up along the inclined portion 11 to avoid the spare tire hitting the rear seat.

A barricade 100 for suppressing a behavior of a spare tire according to embodiments of the present disclosure is formed of a protruding portion 110 and a support portion 120.

Based on the protruding portion 110, the support portions 120 are formed to extend from both end portions of the protruding portion 110 in a width direction, thereby distributing and transmitting a load applied to the protruding portion 110 to the support portions 120 formed at both sides of the protruding portion 110.

The support portion 120 includes an upper support portion 121 coupled to a front upper end portion of the spare tire well panel 10 and a lower support portion 122 coupled to the inclined portion 11 of the spare tire well panel 10. The support portion 120 may be coupled by welding or other devices.

In addition, the protruding portion 110 has a shape protruding from the front upper end portion of the spare tire well panel 10 to a rear side (tire side) and is spaced apart from the inclined portion 11 of the spare tire well panel 10 and disposed upward from the inclined portion 11.

Therefore, it is possible to block the forward behavior of the spare tire 20 by intensively hitting the moving spare tire 20 by the protruding portion 110 protruding to the spare tire 20 side.

Therefore, since the spare tire 20 may not move forward anymore, the behavior is stopped, and a rear portion of the spare tire 20 is lifted to move up, it is possible to prevent the occurrence of the phenomenon in which the spare tire 20 hits a seatback of the rear seat.

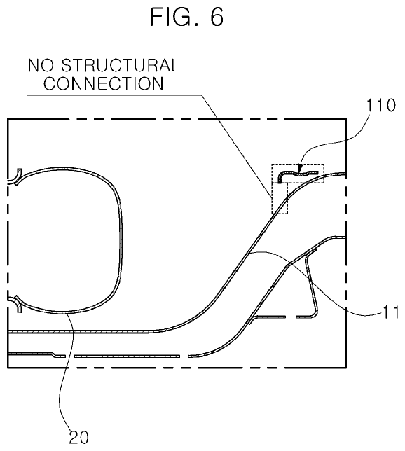

In particular, as illustrated in FIG. 6, when the protruding portion 110 is mounted to be spaced apart from the inclined portion 11 and the spare tire well panel 10 without being structurally connected thereto, it is more advantageous in preventing the behavior of the spare tire.

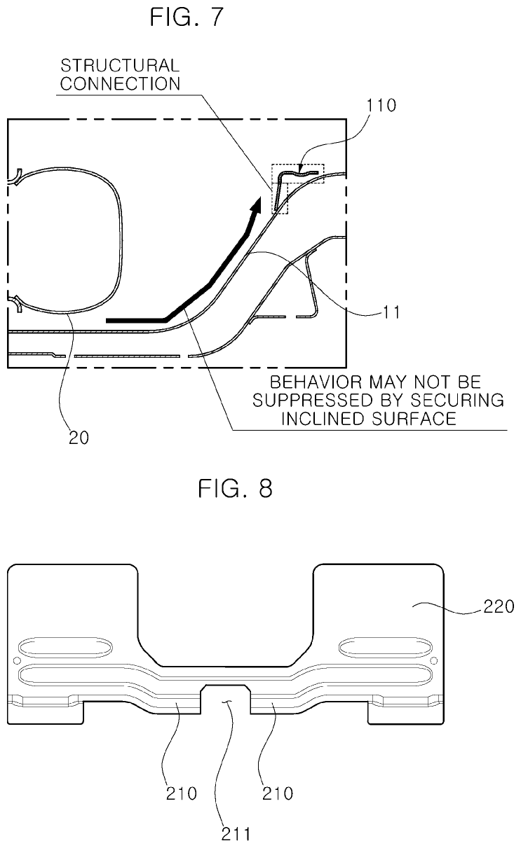

Otherwise, as illustrated in FIG. 7, when the protruding portion 110 is structurally connected to the spare tire well panel 10 downward, the spare tire 20 moves up along the connected inclined surface structure, and thus it is disadvantageous in suppressing the behavior of the spare tire 20.

Therefore, the protruding portion 110 according to embodiments of the present disclosure has a structure that separates the inclined portion 11 from the spare tire well panel 10 to reliably block the behavior of the spare tire 20, and instead, the support portions 120 formed at both sides of the protruding portion 110 are coupled to the spare tire well panel 10 to distribute the load.

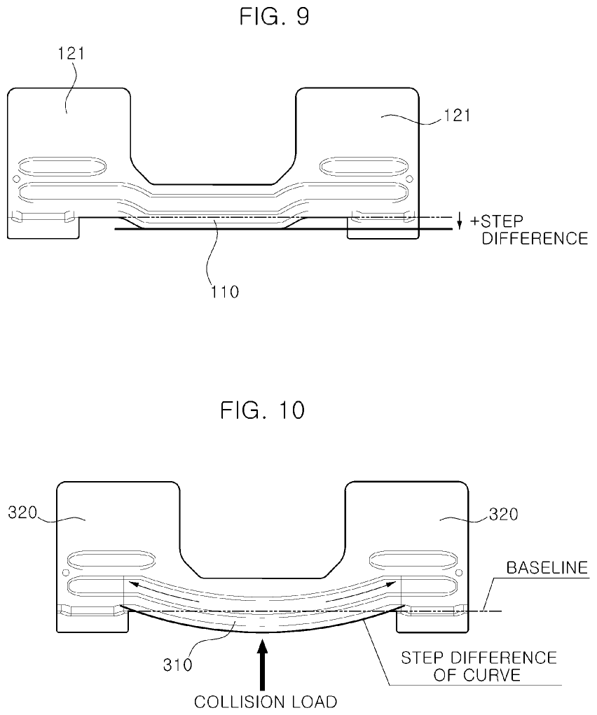

Next, FIGS. 8 to 10 are views for describing applied shapes of the barricade according to embodiments of the present disclosure.

First, a barricade according to an application embodiment of FIG. 8 is a case in which a protruding portion 210 and a support portion 220 are included, and two protruding portions 210 are applied. As described above, a plurality of protruding portions may be formed, and a cutout portion 211 may be formed between the protruding portions.

According to such a barricade, it is possible to optimize collision performance by adjusting a delay time of the behavior by the number of protruding portions.

In addition, FIG. 9 is a view illustrating a step difference between the rear end of the upper support portion 121 and the rear end of the protruding portion 110, and it is also possible to optimize the collision performance by adjusting the delay time of the behavior by adjusting the number of protruding portions.

Next, a barricade according to an application embodiment of FIG. 10 is an application example in which a protruding portion 310 and a support portion 320 are included, and the protruding portion 310 is formed as a curved protruding portion having a rearward rounded shape.

In other words, the barricade may be applied by transforming the step difference compared to a baseline into a streamlined shape, and in this case, a streamlined protruding portion is advantageous in transmitting the load backward compared to a straight step difference.

This is because the streamlined shape minimizes load transmission loss horizontally in both directions, and the corresponding shape may be selectively applied depending on a vehicle type and performance.

Furthermore, by applying the application example of FIG. 10 together with the application example of FIG. 8, a plurality of curved protruding portions may be separately formed.

As described above, according to the barricade of embodiments of the present disclosure, it is possible to promote a passenger's safety by blocking the behavior of the spare tire when the vehicle is driven to the rear side to block the behavior of the spare tire.

Although embodiments of the present disclosure have been described above with reference to the exemplary drawings, embodiments of the present disclosure are not limited to the described embodiments, and it is apparent to those skilled in the art that various modifications and changes can be made without departing from the spirit and scope of the embodiments of the present disclosure. Therefore, these modified examples or changed examples should be included in the claims of the present disclosure, and the scope of the embodiments of the present disclosure should be construed based on the appended claims.

What is claimed is:

1. A barricade for suppressing a behavior of a spare tire, the barricade comprising:
a support portion configured to be mounted on a spare tire well panel; and
a protruding portion extending from the support portion and protruding to a spare tire side.

2. The barricade of claim 1, wherein the protruding portion is spaced apart from the spare tire well panel.

3. The barricade of claim 2, wherein the protruding portion is spaced apart from an inclined portion that is inclined from a front upper end portion of the spare tire well panel to a recessed portion of the spare tire well panel, wherein the recessed portion is configured to accommodate the spare tire.

4. The barricade of claim 1, wherein:
the support portion is configured as a pair of the support portions; and
each of the support portions extends from a respective end portion of the protruding portion in a width direction.

5. The barricade of claim 4, wherein each of the support portions comprises:
an upper support portion coupled to a front upper end portion of the spare tire well panel; and
a lower support portion coupled to an inclined portion inclined from the front upper end portion of the spare tire well panel to a recessed portion of the spare tire well panel, wherein the recessed portion is configured to accommodate the spare tire.

6. The barricade of claim 1, further comprising a plurality of the protruding portions spaced apart from the spare tire well panel and spaced apart from each other, wherein a cutout portion is disposed between the plurality of protruding portions.

7. The barricade of claim 1, wherein the protruding portion is spaced apart from the spare tire well panel, and wherein the protruding portion has a shape rounded to be convex to the spare tire side.

8. The barricade of claim 7, further comprising a plurality of protruding portions spaced apart from the spare tire well panel and spaced apart from each other, wherein a cutout portion is disposed between the plurality of protruding portions.

9. A barricade configured to suppress a behavior of a spare tire accommodated in a spare tire well panel, the barricade comprising:
a pair of support portions configured to be mounted on the spare tire well panel; and
a protruding portion extending between the support portions, protruding to a spare tire side of the spare tire well panel, and spaced apart from the spare tire well panel, wherein each of the support portions extends from a respective end portion of the protruding portion in a width direction.

10. The barricade of claim 9, wherein each of the support portions comprises:
an upper support portion coupled to a front upper end portion of the spare tire well panel; and
a lower support portion coupled to an inclined portion inclined from the front upper end portion of the spare tire well panel to a recessed portion of the spare tire well panel, wherein the recessed portion is configured to accommodate the spare tire.

11. The barricade of claim 9, further comprising a plurality of protruding portions spaced apart from each other between the support portions, wherein a cutout portion is disposed between the plurality of protruding portions, and wherein each of the support portions extends from a respective end portion of outermost ones of the protruding portions in the width direction.

12. The barricade of claim 9, wherein the protruding portion has a shape rounded to be convex to the spare tire side.

13. The barricade of claim 12, further comprising a plurality of the protruding portions spaced apart from each other between the support portions, a cutout portion is disposed between the plurality of protruding portions, and wherein each of the support portions extends from a respective end portion of outermost ones of the protruding portions in the width direction.

14. A vehicle comprising:
a vehicle body comprising a trunk;
a spare tire well panel disposed in the trunk;
a spare tire accommodated in the spare tire well panel;
a support portion mounted on the spare tire well panel; and
a protruding portion extending from the support portion and protruding in a direction toward the spare tire, wherein the protruding portion is spaced apart from the spare tire well panel.

15. The vehicle of claim 14, wherein the protruding portion is spaced apart from an inclined portion of the spare tire well panel, wherein the inclined portion is inclined from a front upper end portion of the spare tire well panel to a recessed portion of the spare tire well panel that accommodates the spare tire.

16. The vehicle of claim 14, wherein:
the support portion comprises a pair of the support portions; and
each of the support portions extends from a respective end portion of the protruding portion in a width direction of the vehicle.

17. The vehicle of claim 16, wherein each of the support portions comprises:
an upper support portion coupled to a front upper end portion of the spare tire well panel; and
a lower support portion coupled to an inclined portion inclined from the front upper end portion of the spare tire well panel to a recessed portion of the spare tire well panel that accommodates the spare tire.

18. The vehicle of claim 14, further comprising a plurality of the protruding portions spaced apart from each other, wherein a cutout portion is disposed between the plurality of protruding portions.

19. The vehicle of claim 14, wherein the protruding portion has a shape rounded to be convex toward the direction of the spare tire.

20. The vehicle of claim 19, further comprising a plurality of the protruding portions spaced apart from each other, wherein a cutout portion is disposed between the plurality of protruding portions.
